(19) United States
(12) Patent Application Publication
(10) Pub. No.: US 2009/0269577 A1
(43) Pub. Date: Oct. 29, 2009

(54) WATERBORNE ANTI-CHIP PRIMER COATING COMPOSITION

(75) Inventors: Paul H. Lamers, Allison Park, PA (US); Christopher A. Verardi, Pittsburgh, PA (US); Michele L. Meli, Ambridge, PA (US); Carolyn A.K. Novak, Gibsonia, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/108,602

(22) Filed: Apr. 24, 2008

(51) Int. Cl. C08G 63/00; B05D 3/00

(52) U.S. Cl. 428/336; 528/271; 427/385.5

(57) ABSTRACT

The present invention is directed to towards a waterborne anti-chip primer coating composition comprising a polyester polyol having a molecular weight ≧1500 wherein the polyester polyol comprises ≧30 weight % of the total resin solids of the waterborne anti-chip primer coating composition; and wherein after application to a substrate as a coating and after curing has a dry film thickness ranging from 2 μm to 8 μm.

### BACKGROUND OF THE INVENTION

1. Field of the Invention

The present invention relates to a waterborne anti-chip primer coating composition comprising a polyester polyol having a molecular weight ≧1500.

2. Background Information

Anti-chip primer coating compositions based upon chain extended, high molecular weight polyurethane dispersions are known in the automotive OEM industry. These anti-chip primer coating compositions are generally applied onto various locations of a vehicle. Normally, the anti-chip primer coating compositions are applied onto the leading edges of doors, fenders, hoods and on the A pillar of a vehicle prior to application of a primer-surfacer coating composition over the entire vehicular body. The anti-chip primer coating composition is typically not cured prior to application of the primer-surfacer coating composition. Rather, the anti-chip primer coating composition is subjected to an ambient flash step, wherein the anti-chip primer coating composition is exposed to ambient air for a certain period of time in order to allow for the evaporation of a portion of organic solvent from the anti-chip coating composition, prior to application of the primer-surfacer coating composition. After the primer-surfacer coating composition is applied onto the anti-chip primer coating composition, both layers are then simultaneously cured (co-cured).

The presence of the anti-chip primer layer provides an exceptional degree of chip resistance to the portions of the vehicle onto which it is applied. However, urethane based anti-chip primer coating compositions are generally formulated with high amounts of organic solvent in order to minimize the tendency of these materials to surface dry. Unless high amounts of organic solvent are used in a urethane based anti-chip primer coating composition, the coating composition typically cannot be applied via a high speed rotary atomizer due to the fact that the coating composition would dry on the high speed rotary atomizer which leads to downtime since the high speed rotary atomizer would have to be cleaned periodically. Accordingly, urethane based anti-chip primer coating compositions are typically applied manually onto a vehicle via air atomized guns. Therefore, there is a need for an anti-chip primer coating composition that comprises low amounts of volatile organic compounds (VOCs), such as organic solvent, which may be applied by high speed rotary atomizers.

### SUMMARY OF THE INVENTION

The present invention is directed to towards a waterborne anti-chip primer coating composition comprising a polyester polyol wherein the polyester polyol has a molecular weight ≧1500 wherein the polyester polyol comprises ≧30 weight % of the total resin solids of the waterborne anti-chip primer coating composition; and wherein after application to a substrate as a coating and after curing has a dry film thickness ranging from 2 μm to 8 μm.

The present invention is also directed to a method of coating a substrate comprising applying a waterborne anti-chip primer coating composition onto at least a portion of the substrate, wherein the waterborne anti-chip primer coating composition comprises a polyester polyol having a molecular weight ≧1500, and wherein the polyester polyol comprises ≧30 weight % of the total resin solids of the waterborne anti-chip primer coating composition; and curing said waterborne anti-chip primer coating composition such that the waterborne anti-chip primer coating composition has a dry film thickness ranging from 2 μm to 8 μm.

The present invention is also directed towards a substrate comprising a coating system wherein the coating system comprises an anti-chip primer coating layer having a thickness ranging from 2 μm to 8 μm, and wherein the anti-chip primer coating layer results from a waterborne anti-chip coating composition comprising a polyester polyol wherein the polyester polyol has a molecular weight ≧1500, and wherein the polyester polyol comprises ≧30 weight % of the total resin solids of the waterborne anti-chip primer coating composition.

The present invention is also directed towards a waterborne anti-chip primer coating composition comprising the reaction product of a polyester polyol having a molecular weight ≧1500 and an acrylate monomer, wherein the reaction product comprises ≧30 weight % of the total resin solids of the waterborne anti-chip primer coating composition; and wherein after application to a substrate as a coating and after curing has a dry film thickness ranging from 2 μm to 8 μm.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Plural encompasses singular and vice versa. For example, although reference is made herein to “a” trimellitic anhydride, “a” polyol, “a” polyester polyol, a combination (i.e., a plurality) of trimellitic anhydrides, polyols, and/or polyesters may be used.

As used herein, “plurality” means two or more.

As used herein, “includes” and like terms means “including without limitation.”

It will be understood that the various coating layers that are described herein result from various coating compositions. For example, the electrodeposited coating layer result from an electrodepositable coating composition after such coating composition is substantially cured.

As used herein, the term “cure” refers to a coating wherein any crosslinkable components of the composition are at least partially crosslinked. In certain embodiments, the crosslink density of the crosslinkable components (i.e., the degree of crosslinking) ranges from 5% to 100%, such as 35% to 85%, or, in some cases, 50% to 85% of complete crosslinking. One skilled in the art will understand that the presence and degree of crosslinking (i.e., the crosslink density) can be determined by a variety of methods, such as dynamic mechanical thermal analysis (DMTA) using a Polymer Laboratories MK III DMTA analyzer conducted under nitrogen.

As used herein, molecular weight refers to number average molecular weight (Mₙ) as determined by Gel Permeation Chromatography.

When referring to any numerical range of values, such ranges are understood to include each and every number and/or fraction between the stated range minimum and maximum.

### Waterborne Anti-Chip Primer Coating Composition

In certain embodiments, the present invention is directed to a waterborne anti-chip primer coating composition comprising a polyester polyol having a molecular weight of ≧1500 wherein the polyester polyol comprises ≧30 weight % of the total resin solids of the waterborne anti-chip coating composition. As used herein, “anti-chip primer coating composition” means a coating composition that is applied onto at least a portion of an underlying electrodeposited coating layer and onto which a subsequent coating composition, such as a primer-surfacer coating composition and/or a color imparting (basecoat) coating composition is applied. It should be noted that an anti-chip primer coating layer is not synonymous to a primer-surfacer coating layer.

One skilled in the art would regard a primer-surfacer coating layer as a coating layer whose function is typically three fold: (1) to fill-in the surface irregularities of an underlying coating layer; (2) to provide a degree of chip resistance to the substrate onto which it is applied; and (3) to provide intercoat adhesion between the substrate onto which the primer-surfacer layer is applied and the coating layer(s) that are subsequently applied onto (over) the primer-surfacer coating layer. The primer-surfacer coating layer typically has a dry film thickness ranging from 25 μm to 40 μm. Additionally, a cured primer-surfacer coating layer must possess the physical properties which allow it to be sanded (sandable) so that any surface defects that may be found on the cured primer-surfacer coating layer may be removed by mechanical means.

In contrast, one skilled in the art would regard an anti-chip primer coating layer as a coating layer whose function is to provide the highest degree of chip resistance to the substrate onto which it is applied when compared to any other coating layer that is applied onto the substrate. Accordingly, the anti-chip primer coating layer is typically found on the most chip prone regions of a vehicle. Unlike the primer-surfacer coating layer, the anti-chip primer coating layer typically has a dry film thickness ranging from 2 μm to 8 μm, such as from 6 μm to 8 μm. Additionally, unlike the primer-surfacer coating layer, the anti-chip primer coating layer typically does not possess the physical properties that is required for it to be sanded.

It be noted that “anti-chip” does not mean that the coating layer is 100% resistant to chip defects. Rather, it means that the coating layer is more resistance to chip defects when compared to any other layer that is applied onto the substrate. In certain embodiments, the coating composition contains reduced amounts of volatile organic compounds. For example, in certain embodiments, the total amount of organic solvent used in the present invention can be ≦10% of the total resin content of the waterborne anti-chip primer coating composition described herein, which is a significant decrease in the amount of organic solvent when compared to urethane based anti-chip primer coating compositions. It has been surprisingly discovered that a decrease in the amount of organic solvent does not affect certain properties of the resulting anti-chip coating layer. For example, the anti-chip coating layer that is derived using the waterborne anti-chip coating composition of the present invention attains anti-chip performance that is equal to or surpasses that of an urethane based anti-chip primer coating composition.

The waterborne anti-chip primer coating composition disclosed in this invention comprises a polyester polyol which is the reaction product of an acid and a polyol.

Any acid known in the art may be used to form the polyester polyol described herein. By way of example, suitable acids that may be utilized to form the polyester polyol include, without limitation, trimellitic anhydride, pyromellitic anhydride, or combinations thereof.

Any acid known in the art may be utilized to form the polyester polyol described herein. By way of example, suitable polyols that may be used to form the polyester polyol include, without limitation, the condensation reaction products of diols with diacids, a urethane diol, a polyether polyol, polytetramethylene ether glycols, polypropylene glycol, polyethylene glycol, bisphenol A, bisphenol A ethoxylates, or combinations thereof.

One skilled in the art would appreciate that the polyester polyol reaction product described herein will comprise the residues of the reactants used to form the reaction product. The polyester polyol, therefore, will comprise the residues of the acid and the polyol used to form the polyester polyol. The polyester polyol described herein can either be branched or not branched. As used herein, “branch” means that a plurality of moieties is connected to a primary branching point. As used herein, “primary branching point” refers to a component in a molecule or a residue of a molecule that connects ≧2 moieties. For example, in certain embodiments, the primary branching point in the polyester polyol can be the acid residue from which 2 polyol residues extend (each polyol residue being considered a branch).

In certain embodiments, the waterborne anti-chip primer coating composition of the present invention can comprise a polyester polyol that is a reaction product of a polyether diol and trimellitic anhydride. Suitable polyether diols that may be utilized in the present invention include, without limitation, polytetramethyleneglycol or polyproypleneglycol based polyethers. In certain embodiments, the polyether diol has a molecular weight that ranges from 250 to 2000. In certain embodiments, the molar ratio of polyether diol to trimellitic anhydride can range from 4:2 to 5:3. Depending on the desired number of branches in the polyester polyol reaction product, the molar ratio can be varied within the range described in the preceding sentence. In certain embodiments, the reaction between the polyether diol and trimellitic anhydride is conducted at a temperature ≧180° C. for a sufficient amount of time to bring the acid value of the combined ingredients to 25-30. As used herein, “acid value” means the mass of potassium hydroxide (KOH) (in milligrams) required to neutralize one gram of a chemical substance in the reaction mixture (i.e., trimellitic anhydride and/or polyether diol). In certain embodiments, the trimellitic anhydride serves as the primary branching point with 3 polyether diols branching from the trimellitic anhydride. In other embodiments, however, a single trimellitic anhydride may be bonded to one adjacent trimellitic anhydride while also being bonded to two polyether diols.

In certain embodiments, the polyester polyol comprises ≧30 weight %, such as 50 weight % to 85 weight %, of the total resin solids of the waterborne anti-chip primer coating composition of the present invention.

In certain embodiments, the waterborne anti-chip coating composition of the present invention may further comprise a cross-linking agent (curing agent) that is reactive with the hydroxyl reactive functional groups of the polyester polyol. Suitable cross-linking agents that may be utilized in the present invention include, without limitation, melamine, isocyanate (including blocked isocyanate), or combinations thereof. In certain embodiments, cross-linking agent comprises 0 weight % to 40 weight % of the total resin solids of the waterborne anti-chip primer coating composition.

In certain embodiments, the waterborne anti-chip primer coating composition comprises the reaction product of the polyester polyol described herein and a polymerizable ethylenically unsaturated monomer, such as an alkyl(meth)acrylate having 1 to 20 carbon atoms in the alkyl groups. Suitable polymerizable ethylenically unsaturated monomers that may be used in the present invention include, but are not limited to methyl acrylate, ethyl acrylate, butyl acrylate, 2-ethylhexyl acrylate, methyl methacrylate, butyl methacrylate, 2-ethylhexyl methacrylate, hydroxyethyl methacrylate, hydroxypropyl acrylate, styrene, and the like.

In certain embodiments, the weight % ratio of polyester polyol to acrylate in the reaction product ranges from 90:10 to 60:40 based on the total resin solids of the reaction product.

In certain embodiments, the reaction product described in the preceding paragraph comprises ≧30 weight %, such as such as 50 weight % to 85 weight %, of the total resin solids of the waterborne anti-chip primer coating composition of the present invention.

In certain embodiments, the waterborne anti-chip coating composition further comprises one or more additional film-forming polymers. The additional film-forming polymer has functional groups that are reactive with either themselves or a curing agent, such as those described below. The additional film-forming polymer can be selected from, for example, acrylic polymers, polyester polymers, polyurethane polymers, polyamide polymers, polyether polymers, polysiloxane polymers, copolymers thereof, and mixtures thereof. Generally, these polymers can be any polymers of these types made by any method known to those skilled in the art. Such polymers may be solvent borne or water dispersible, emulsifiable, or of limited water solubility. The functional groups on the film-forming resin may be selected from any of a variety of reactive functional groups including, without limitation, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof.

Suitable curing agents that can be react with the reactive functional groups of the additional film-forming polymer include, without limitation, aminoplasts, polyisocyanates (including blocked isocyanates), polyepoxides, betahydroxyalkylamides, polyacids, anhydrides, organometallic acid-functional materials, polyamines, polyamides, and mixtures of any of the foregoing.

### Coating System

A substrate may be coated with a coating system that comprises an anti-chip primer coating layer deposited from the waterborne anti-chip coating composition of the present invention. In certain embodiments, the coating system can comprise a plurality of coating layers such as an electrodeposited coating layer, a color-imparting coating layer (basecoat), and/or a substantially clear coating layer (clearcoat).

For example, in certain embodiments, the coating system comprises an electrodeposited coating layer deposited onto at least a portion of a substrate, the waterborne anti-chip primer coating layer described herein deposited onto at least a portion of the electrodeposited coating layer, one or more basecoat layers deposited onto at least a portion of the waterborne anti-chip primer coating layer, and a clearcoat layer deposited onto at least a portion of the one or more basecoat layers.

In certain embodiments, the waterborne anti-chip coating composition described herein can be deposited onto at least a portion of an electrodeposited coating layer. The electrodeposited coating layer can either be electrodeposited onto at least a portion of the automotive substrate or it can be electrodeposited onto a least a portion of an underlying coating layer, such as an underlying pretreatment layer. Any electrodepositable coating composition can be used to form the electrodeposited coating layer described herein. For example, in certain embodiments, the electrodepositable coating composition described in U.S. patent application Ser. No. 11/835,600, which is incorporated herein in its entirety by reference, can be used.

In certain embodiments, a primer-surfacer coating layer is applied over at least a portion of the anti-chip primer coating layer. Any primer-surfacer coating composition may be used in the present invention. For example, in certain embodiments, the primer-surfacer coating composition that is described in U.S. patent application Ser. Nos. 11/773,482 and/or 11/533,518, which are incorporated in their entirety herein by reference, can be used.

Accordingly, in certain embodiments, the primer-surfacer coating composition comprises the reaction product of trimellitic anhydride and a polyol, wherein the molar ratio of trimellitic anhydride to said polyol in said reaction product ranges from 1:2 to 1:4, and wherein the reaction product is further reacted with an anhydride to form another reaction product. Suitable polyols that may be used to form the reaction product include, without limitation, a polyester polyol, a urethane diol, a polyether polyol, polytetramethylene ether glycols, polypropylene glycol, polyethylene glycol, bisphenol A, bisphenol A ethoxylates.

In one embodiment, a polyol is reacted with trimellitic anhydride at a temperature ranging from 200° C. to 230° C. for a time period ranging from 6 hours to 10 hours. At this temperature range, the anhydride ring of trimellitic anhydride “opens” and a reaction occurs between the trimellitic anhydride and the hydroxyl functional group of the polyol such that an ester bond is formed between the “opened” trimellitic anhydride and the polyol (hereinafter, referred to as the “condensation stage”). Moreover, the reaction between the trimellitic anhydride and the polyol in the “condensation stage” also creates a carboxylic acid functional group on the “opened” trimellitic anhydride. Accordingly, the trimellitic anhydride will have two carboxylic acid functional groups that are available for further reaction. The two carboxylic acid functional groups of the open-ring trimellitic anhydride may then be reacted with additional polyols via condensation reactions to produce a branched triol. Accordingly, the reaction product will have unreacted terminal hydroxyl groups.

At least some of the reaction product that is formed during the “condensation stage”, is then further reacted with an anhydride at a temperature ranging from 140° C. to 170° C. in order to render the branched triol dispersible (e.g., water dispersible). Suitable anhydrides that could be used to react with the reaction product would include, but are not be limited to, trimellitic anhydride, phthalic anhydride, hexahydrophthalic anhydride, tetrahydrophthalic anhydride, methyl hexahydrophthalic anhydride, succinic anhydride, maleic anhydride. In one embodiment, 0.33 moles of trimellitic anhydride is added to 1 mole of the reaction product at a temperature ranging from 140° C. to 170° C. At this temperature range, the anhydride ring of trimellitic anhydride “opens” and a reaction occurs between the trimellitic anhydride and a hydroxyl functional group of the reaction product such that an ester bond is formed between the trimellitic anhydride and the reaction product (hereinafter, referred to as the “ring opening stage”). The reaction between trimellitic anhydride and the reaction product in the “ring opening stage” produces a carboxylic acid functional group on the “opened” trimellitic anhydride, which increases the dispersablity (e.g., water dispersability) of the reaction product produced during the “ring opening stage”. Moreover, the resulting reaction product, which is now dispersible, comprises a number of hydroxyl functional groups that can be used, if the dispersion is used in a coating, to cure the coating. For example, hydroxyl functional groups of the polyol can react with a melamine curing agent to form a cross-linked coating.

Additionally, in certain embodiments, the primer-surfacer coating composition can comprise (a) polymeric microparticles obtained by aqueous phase addition polymerization of a monomer component comprising one or more addition polymerizable ethylenically unsaturated monomers in the presence of a polymer dispersed in aqueous medium in which the polymer is selected from a polyester, a polyurethane and an acrylic copolymer including mixtures thereof, (b) a water-dilutable urethane polyol, and (c) a hydroxyl group-containing material derived from the reaction of an epoxy group-containing material with a phosphorus acid.

The polymeric microparticles (a) are obtained by aqueous phase addition polymerization of a polymerizable ethylenically unsaturated monomer component in the presence of the aqueous resinous dispersions mentioned in the preceding paragraph.

The ethylenically unsaturated monomer component may be a mixture of monomers that is capable of free radical initiated polymerization in aqueous medium. In certain embodiments, the monomer mixture contains from 0 weight % to 40 weight %, such as from 5 weight % to 25 weight %, of a hydroxy functional monomer. An example of a suitable hydroxy functional monomer would include, without limitation, hydroxyethyl methacrylate, hydroxypropyl acrylate, or combinations thereof. The percentage by weight being based on total monomer weight.

The other monomer in the mixture can be selected from suitable monomers known in the art including but not limited to vinylidene halides, such as chlorides and fluorides; alkyl acrylates and methacrylates, vinyl esters of organic acids and alkyl esters of maleic and fumaric acid.

Besides the monomers mentioned above, other polymerizable alpha, beta-ethylenically unsaturated monomers can be used and may include olefins such as ethylene and propylene; vinyl aromatic compounds such as styrene and vinyl toluene; vinyl ethers and ketones such as methyl vinyl ether and methyl vinyl ketone; conjugated dienes such as butadiene and isoprene; nitriles such as acrylonitrile; amides such as acrylamide and methacrylamide and alkoxyalkyl derivatives thereof such as N-butoxymethylmethacrylamide.

The amount of the ethylenically unsaturated monomer component may vary. In certain embodiments, it may be used in amounts ranging from 5 weight % to 95 weight %, such as from 25 weight % to 75 weight %, based on the total resin solid weight of polymerizable ethylenically unsaturated monomer component and the dispersed polymer. The dispersed polymer may be present in varying amounts. In certain embodiments, it may be present in an amount ranging from 5 weight % to 95 weight %, such as from 25 weight % to 75 weight %, based on total resin solid weight of the polymerizable ethylenically unsaturated monomer and the dispersed polymer.

With regard to the conditions of polymerization, the polymerizable ethylenically unsaturated monomer component may be addition polymerized in aqueous medium in the presence of the dispersed polymer, with a free radical initiator, comprising from 0.2 weight % to 1.0 weight % based on total resin solid weight of the polymerizable ethylenically unsaturated monomer and dispersed polymer. The temperature of polymerization may vary. In an embodiment, it may be from 0° C. to 100° C., or from 20° to 85° C. The pH of the aqueous medium may be maintained from 5 to 12.

The free radical initiator can be selected from those known in the art and may include one or more peroxides which are known to act as free radical initiators and which are soluble in aqueous medium. Examples include but are not limited to the persulfates such as ammonium, sodium and potassium persulfate. Also, oil-soluble initiators may be employed either alone or in addition to the water-soluble initiators. Suitable oil-soluble initiators may include organic peroxides such as benzoyl peroxide, t-butyl hydroperoxide, and t-butyl perbenzoate. Azo compounds such as azobisisobutyronitrile can also be used.

The polymeric microparticles may be present in the primer-surfacer coating composition in amounts ranging from 40 weight % to 90 weight %, such as from 50 weight % to 80 weight %, based on the total resin solids of (a)+(b)+(c). In an embodiment, the polymeric microparticles may have a particle size of from 20 to 100 nanometers (nm). In a further embodiment, the polymeric microparticles may have hydroxyl values of from 50 to 300.

The water-dilutable urethane polyols (b) contain at least two hydroxyl groups and at least one urethane group, or at least two urethane groups. The urethane polyols may be prepared using conventional methods such as by reacting a polyamine with a cyclic carbonate. The polyamine may include linear, branched or cyclic polyamines. The polyamines may contain at least one, or at least two, primary amino groups. They may also contain further secondary or tertiary amino groups or ether groups.

The water-dilutable urethane polyols may be used in various amounts such as the primer-surfacer coating composition may contain from 5 weight % to 30 weight %, such as from 10 weight % to 25 weight %, urethane polyol; the percentage by weight being based on the total resin solids of (a)+(b)+(c).

Component (c), the hydroxy group-containing material may be derived from conventional methods such as from reacting an epoxy group-containing material with a phosphorus acid. In an embodiment, these materials may be prepared by reacting phosphoric acid or an organic phosphonic acid that are at least dibasic with epoxy resins optionally in a solvent. The amount of the phosphoric or phosphonic acid used is normally such that all of the epoxide groups are consumed by the reaction with the acid and such that a sufficient number of acid groups is still available after the reaction. The resulting resin has hydroxyl groups (from the reaction of the oxirane group with acid functionality), these hydroxyl groups being positioned beta to the ester group, and also acid groups of the phosphoric or phosphonic acid that were not consumed by the reaction with the epoxide.

Any suitable epoxide may be used and may include those known in the art. Non-limiting examples may include polyepoxides such as but not limited to polyglycidyl ether of a polyphenol. Any suitable phosphoric or phosphonic acid may be used and may include those known in the art. Non-limiting examples may include but are not limited to orthophosphoric acid, phosphorus acid, alkanephosphonic acids having 1 to 18, or 1 to 12, carbon atoms in the alkyl radical such as methanephosphonic and ethanephosphonic acid, and also phenylphosphonic acid.

The epoxy-phosphorous reaction product may be present in the aqueous resinous binder in amounts of from 2 weight % to 20 weight %, such as from 2.5 weight % to 15 weight %, based on the total resin solids of (a)+(b)+(c).

It should be noted that in certain embodiments, the primer-surfacer coating layer is not utilized in the coating system that is applied onto the substrate.

In certain embodiments, when the coating system comprises the primer-surfacer layer, a color-imparting coating layer can be applied directly onto at least a portion of a substrate or onto at least a portion of any underlying coating layer or an underlying coating composition. In embodiments where the coating system does not comprise the primer-surfacer layer, the color-imparting coating layer can be applied onto at least a portion of the anti-chip primer coating layer described herein. The basecoat composition comprises a colorant, such as those described below, which results in a colored coating layer that can be deposited onto the substrate.

In certain embodiments, a substantially clear coating layer is applied onto at least a portion of the basecoat coating layer. As used herein, a “substantially clear” coating layer is substantially transparent and not opaque when cured. In certain embodiments, the substantially clear coating layer can comprise a colorant but not in an amount such as to render the clear coating layer opaque. Any clearcoat coating composition known in the art may be used in conjunction with the present invention. For example, the clearcoat coating composition that is described in U.S. Pat. No. 6,387,519 B1, which is incorporated in its entirety herein by reference, may be used in the present invention. In certain embodiments, the substantially clear coating layer can also comprise a particle, such as a silica particle, that is dispersed in the clearcoat coating layer (such as at the surface of the clearcoat coating layer).

It will be further appreciated that the coating compositions described herein can be either “one component” (“1K”), “two component” (“2K”), or even multi-component compositions. A 1K composition will be understood as referring to a composition wherein all of the coating components are maintained in the same container after manufacture, during storage, etc. A 1K coating can be applied to a substrate and cured by any conventional means, such as by heating, forced air, and the like. The present coatings can also be 2K coatings or multi-component coatings, which will be understood as coating in which various components are maintained separately until just prior to application.

In certain embodiments, one or more coating compositions from which the various coating layers described herein result can comprise a cross-linking agent. Suitable cross-linking agents include, without limitation, aminoplasts, polyisocyanates (including blocked isocyanates), polyepoxides, beta-hydroxyalkylamides, polyacids, anhydrides, organometallic acid-functional materials, polyamines, polyamides, and mixtures of any of the foregoing.

In certain embodiments, the coating compositions that form the coating layers described herein can include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coating composition described herein.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated in its entirety herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated in its entirety herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated in its entirety herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating composition described herein. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in any amount sufficient to impart the desired visual and/or color effect. The colorant may comprise from 1 to 65 weight % of the present compositions, such as from 3 to 40 weight % or 5 to 35 weight %, with weight percent based on the total weight of the compositions.

The coating compositions can comprise other optional materials well known in the art of formulated surface coatings, such as plasticizers, anti-oxidants, hindered amine light stabilizers, UV light absorbers and stabilizers, surfactants, flow control agents, thixotropic agents such as bentonite clay, pigments, fillers, organic cosolvents, catalysts, including phosphonic acids and other customary auxiliaries.

The type of substrate onto which the anti-chip primer coating composition is applied is not meant to be limiting and, therefore, includes metal substrates, metal alloy substrates, and/or substrates that has been metallized, such as nickel plated plastic. In certain embodiments, the metal or metal alloy can be aluminum and/or steel. For example, the steel substrate could be cold rolled steel, electrogalvanized steel, and hot dipped galvanized steel. In certain embodiments, the substrate may comprise a portion of a vehicle such as a vehicular body (e.g., without limitation, door, body panel, trunk deck lid, roof panel, hood, and/or roof) and/or a vehicular frame. As used herein, “vehicle” or variations thereof includes, but is not limited to, civilian, commercial, and military land vehicles such as cars, motorcycles, and trucks. It will also be understood that, in certain embodiments, the substrate may be pretreated with a pretreatment solution, such as a zinc phosphate solution as described in U.S. Pat. No. 5,238,506, which is incorporated in its entirety herein by reference, or not pretreated with a pretreatment solution. For clarity, when referring to an “automotive substrate” herein, it should be noted that the automotive substrate may or may not be pretreated.

The coating compositions that form the various coating layers described herein can be deposited or applied onto the substrate using any technique that is known in the art. For example, the coating compositions can be applied to the substrate by any of a variety of methods including, without limitation, spraying, brushing, dipping, and/or roll coating, among other methods. When a plurality of coating compositions are applied onto a substrate, it should be noted that one coating composition may be applied onto at least a portion of an underlying coating composition either after the underlying coating composition has been cured or prior to the underlying coating composition being cured (e.g., wet-on-wet process). For example, in certain embodiments, the waterborne anti-chip coating composition is not cured prior to application of a subsequent coating composition(s) (e.g., primer-surfacer coating composition, basecoat coating composition, clearcoat coating composition). If a coating composition is applied onto an underlying coating composition that has not been cured, then both coating compositions may be cured simultaneously (co-cured).

The coating compositions may be cured using any technique that is known in the art. For example, the coating composition may be cured using curing methods including, but not limited to, thermal energy, infrared, ionizing or actinic radiation, or by any combination thereof. In certain embodiments, the curing operation can be carried out at temperatures ≧10° C. In other embodiments, the curing operation can be carried out at temperature ≦246° C. In certain embodiments, the curing operation can carried out at temperatures ranging between any combination of values, which were recited in the preceding sentences, inclusive of the recited values. For example, the curing operation can be carried out at temperatures ranging from 121.1° C.-148.9° C. It should be noted, however, that lower or higher temperatures may be used as necessary to activate the curing mechanisms.

In certain embodiments, the coating compositions described herein a low temperature, moisture curable coating compositions. As used herein, the term “low temperature, moisture curable” refers to coating compositions that, following application to a substrate, are capable of curing in the presence of ambient air, the air having a relative humidity of 10% to 100%, such as 25% to 80%, and a temperature in the range of −10° C. to 120° C., such as 5° C. to 80° C., in some cases 10° C. to 60° C. and, in yet other cases, 15′ to 40° C.

The dry film thickness of the coatings that result from the various coating compositions can range from 0.1 μm to 500 μm. In other embodiments, the dry film thickness can be ≦125 μm, such as ≦80 μm. For example, the dry film thickness can range from 15 μm to 60 μm.

In certain embodiments, the dry film thickness of the anti-chip primer coating layer can range from 2 μm to 8 μm, such as from 5 μm to 7 μm.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

### Polyester 1

A polyester polyol was prepared from the following ingredients

| | Raw Material | Amount (g) |
|---|---|---|
| Chg 1 | Poly THF 650¹ | 1137.5 |
| | Trimellitic anhydride | 201.6 |
| Chg 2 | DMEA | 48.4 |
| | DI Water | 436 |
| | | 1846 |
| Chg 3 | DI Water | |

¹Polytetrahydrofuran available from BASF Corp.

To a four necked, 5 liter reaction flask outfitted with a stirrer, gas inlet, thermometer and condenser was added the contents of Chg 1. The reaction mixture was heated to 185° C. maximum ensuring that the column head temperature did not exceed 100° C. The reaction was held until the acid value was <33. The reaction mixture was then cooled to <100° C., and an aqueous dispersion was produced by adding Chg 2 and Chg 3. The final dispersion had a solids content of 36% and a pH value of 6.0

### Polyester 2

A polyester polyol was prepared from the following ingredients:

| | Raw Material | Amount (g) |
|---|---|---|
| Chg 1 | CHDM | 1037 |
| | pTHF 250¹ | 1800 |
| | Maleic anhydride | 176 |
| | Trimellitic anhydride | 1037 |
| Chg 2 | DMEA | 128 |
| | DI Water | 1153 |
| Chg 3 | DI Water | 5283 |

¹Polytetrahydrofuran available from BASF Corp.

To a four necked, 5 liter reaction flask outfitted with a stirrer, gas inlet, thermometer and condenser was added the contents of Chg 1. The reaction mixture was heated to 185° C. and held until the acid value was 26. A slow nitrogen stream helped remove the water condensate. As soon as an acid number of 26 was reached, the reaction was cooled to <100° C. When the reaction mixture was cooled to <100° C., an aqueous dispersion was produced by adding Chg 2 and Chg 3. The final dispersion had a solids content of 37% and a pH value of 6.5.

### Polyester 3

A polyester polyol was prepared from the following ingredients

| | Raw Material | Amount (g) |
|---|---|---|
| Chg 1 | Poly THF 250¹ | 1000 |
| | Isophthalic acid | 249 |
| | Maleic anhydride | 49 |
| Chg 2 | Trimellitic anhydride | 192 |
| Chg 3 | DMEA | 38 |
| | DI Water | 338 |
| Chg 4 | DI Water | 2023 |

¹Polytetrahydrofuran available from BASF Corp.

To a four necked, 5 liter reaction flask outfitted with a stirrer, gas inlet, thermometer and condenser was added the contents of Chg 1. The reaction mixture was heated to 220° C. maximum ensuring that the column head temperature did not exceed 100° C. After the acid value was reduced to <5, the reaction mixture was cooled to 160° C. and Chg 2 was added. The temperature was then raised to 185° C. and the reaction was held until the acid value was 24. The reaction mixture was then cooled to <100° C., and an aqueous dispersion was produced by adding Chg 3 and Chg 4. The final transparent dispersion had a solids content of 36% and a pH value of 6.0

### Polyester 4

A polyester polyol was prepared from the following ingredients

| | Raw Material | Amount (g) |
|---|---|---|
| Chg 1 | Poly THF 250¹ | 400 |
| | 1,6-Hexanediol | 189 |
| | Isophthalic acid | 133 |
| | Pripol 1013 | 230 |
| | Maleic anhydride | 39 |
| Chg 2 | Trimellitic anhydride | 154 |
| Chg 3 | DMEA | 28.4 |
| | DI Water | 256 |
| Chg 4 | DI Water | 1758 |

¹Polytetrahydrofuran available from BASF Corp.

To a four necked, 5 liter reaction flask outfitted with a stirrer, gas inlet, thermometer and condenser was added the contents of Chg 1. The reaction mixture was heated to 220° C. maximum ensuring that the column head temperature did not exceed 100° C. After the acid value was reduced to <5, the reaction mixture was cooled to 160° C. and Chg 2 was added. The temperature was then raised to 185° C. and the reaction was held until the acid value was 23. The reaction mixture was then cooled to <100° C., and an aqueous dispersion was produced by adding Chg 3 and Chg 4. The final dispersion had a solids content of 34% and a pH value of 6.0

### Polyester 5

A polyester polyol was prepared from the following ingredients

| | Raw Material | Amount (g) |
|---|---|---|
| Chg 1 | Poly THF 650¹ | 877.5 |
| | Cyclohexanedimethanol | 194.4 |
| | Maleic anhydride | 22.1 |
| | Trimellitic anhydride | 259.2 |
| Chg 2 | Butylglycol | 145.9 |
| Chg 3 | DMEA | 49.6 |
| | DI Water | 446.1 |
| Chg 4 | DI Water | 1692 |

¹Polytetrahydrofuran available from BASF Corp.

To a four necked, 5 liter reaction flask outfitted with a stirrer, gas inlet, thermometer and condenser was added the contents of Chg 1. The reaction mixture was heated to 190° C. maximum ensuring that the column head temperature did not exceed 100° C. The reaction mixture was held until the acid value was 32. The reaction mixture was then cooled to <135° C., Chg 2 was added and cooling was continued to 100° C. An aqueous dispersion was produced by adding Chg 3 and Chg 4. The final dispersion had a solids content of 36% and a pH value of 6.0

### Polyester-Acrylate 1

A polyester acrylate was prepared from the following ingredients

| | Raw Material | Amount (g) |
|---|---|---|
| Chg 1 | Polyester 3 | 600 |
| | DI Water | 200 |
| Chg 2 | Hydroxypropylmethacrylate | 14.4 |
| | Styrene | 57.6 |
| Chg 3 | Isoascorbic acid | 0.222 |
| | DI Water | 10 |
| Chg 4 | Ferrous Ammonium Sulfate | 0.0015 |
| | DI Water | 10 |
| Chg 5 | Hydrogen Peroxide (35%) | 1 |
| | DI Water | 5 |
| Chg 6 | DMEA | 2.5 |
| | DI Water | 5 |

To a four necked, 2 liter reaction flask outfitted with a stirrer, gas inlet, thermometer, and condenser was added the contents of Chg 1. While the reaction was heating to 35° C. vacuum was applied to remove the dissolved oxygen. Upon reaching 35° C., the vacuum was broken with a nitrogen stream and the reaction was continued under nitrogen atmosphere. Chg 2 was added followed by stirring for 5 minutes, then Chg 3 & 4 were added followed by stirring for 5 minutes. Chg 5 was then added all at once and within 2 minutes an exotherm ensued. The reaction temperature reached 55° C. within 10 minutes. The reaction was then heated to 65° C. and held for 1 hour to ensure complete monomer conversion. The reaction was then cooled to 35° C. and Chg 6 was added. A nearly transparent dispersion with a solids content of 32% and pH of 6.8 was obtained. A 5 wt: % solution of this polyesteracrylate in tetrahydrofuran showed slight turbidity indicating the presence of crosslinked material.

### Polyester-Acrylate 2

A polyester acrylate was prepared from the following ingredients

| | Raw Material | Amount (g) |
|---|---|---|
| Chg 1 | Polyester 5 | 950 |
| | DI Water | 160 |
| Chg 2 | Hydroxypropylmethacrylate | 22.7 |
| | Styrene | 45.3 |
| | Butyl acrylate | 45.3 |
| Chg 3 | Isoascorbic acid | 0.35 |
| | DI Water | 10 |
| Chg 4 | Ferrous Ammonium Sulfate | 0.0023 |
| | DI Water | 5 |
| Chg 5 | Hydrogen Peroxide (35%) | 1.6 |
| | DI Water | 20 |
| Chg 6 | DMEA | 5.2 |
| | Di Water | 10.4 |
| Chg 7 | DI Water | 50 |

To a four necked, 2 liter reaction flask outfitted with a stirrer, gas inlet, thermometer, and condenser was added the contents of Chg 1. While the reaction was heating to 35° C. vacuum was applied to remove the dissolved oxygen. Upon reaching 35° C., the vacuum was broken with a nitrogen stream and the reaction was continued under nitrogen atmosphere. Chg 2 was added followed by stirring for 5 minutes, then Chg 3 & 4 were added followed by stirring for 5 minutes. Chg 5 was then added all at once and within 2 minutes an exotherm ensued. The reaction temperature reached 53° C. within 10 minutes. The reaction was then heated to 65° C. and held for 1 hour to ensure complete monomer conversion. The reaction was then cooled to 35° C. and Chg's 6 & 7 were added. A nearly transparent dispersion with a solids content of 34% and pH of 6.8 was obtained. A 5 wt: % solution of this polyester—acrylate in tetrahydrofuran showed slight turbidity indicating the presence of crosslinked material.

### Paint Example 1

A pigment paste was first made with the following ingredients:

| | |
|---|---|
| 21.3 g | Polyester 2 |
| 20.3 g | Deionized water |
| 0.38 g | Dimethyl ethanol amine |
| | (50% Solution) |
| 0.76 g | Drewplus L108 |
| | Defoamer from Ashland |
| | Chemicals |
| 1.39 g | Byk-181 Grind additive |
| | from Byk-Chemie |
| 1.5 g | Carbon Black available |
| | from Columbian |
| | Chemicals |
| 0.75 g | Carbon Black available |
| | from Cabot Specialty |
| | Chemicals |
| 0.38 g | Silica from DeGussa |
| 31.7 g | Barium Sulfate from |
| | Solvay |
| 0.23 g | Titanium Dioxide |
| | available from DuPont |
| 2.25 g | Talc from Barretts |
| | Minerals |
| 0.75 g | Yellow iron oxide from |
| | Rockwood Pigments |

These ingredients were first dispersed with a high speed cowls agitator for 1 hour, and then milled for 1½ hours on an Eiger media mill.

To this paste, the remaining ingredients were added with agitation:

| | | |
|---|---|---|
| 167 | g | Polyester 1 |
| 3 | g | Dimethyl ethanol amine |
| | | (50% Solution) |
| 37 | g | Deionized water |
| 4.2 | g | Cymel 327 from Ineos |
| 1.60 | g | Mineral Spirits |
| 1.6 | g | Byk-346 Additive from |
| | | Byk-Chemie |
| 1.5 | g | Byk-381 Additive from |
| | | Byk-Chemie |

Sample was reduced to 34 seconds #4 Ford cup viscosity. The final paint solids was 39% at a P/B ratio of 0.5:1. The organic solvent content of the above formulation is 2%. The effective resin solids content (minus water) is 94%. As used herein, “effective resin solids content (minus water)” can be calculated by the following formula:

resin solids (in grams)/(resin (in grams)+solvent (in grams))

Deposition of 100 g of the above anti-chip resin solids on the part will result in the environmental release of 6 g of solvent from this formulation.

### Paint Example 2

A pigment paste was first made with the following ingredients:

| | |
|---|---|
| 21.3 g | Polyester 2 |
| 20.3 g | Deionized water |
| 0.38 g | Dimethyl ethanol amine |
| | (50% Solution) |
| 0.76 g | Drewplus L108 |
| | Defoamer from Ashland |
| | Chemicals |
| 1.39 g | Byk-181 Grind additive |
| | from Byk-Chemie |
| 1.5 g | Carbon Black available |
| | from Columbian |
| | Chemicals |
| 0.75 g | Carbon Black available |
| | from Cabot Specialty |
| | Chemicals |
| 0.38 g | Silica from DeGussa |
| 31.7 g | Barium Sulfate from |
| | Solvay |
| 0.23 g | Titanium Dioxide |
| | available from DuPont |
| 2.25 g | Talc from Barretts |
| | Minerals |
| 0.75 g | Yellow iron oxide from |
| | Rockwood Pigments |

These ingredients were first dispersed with a high speed cowls agitator for 1 hour, and then milled for 1½ hours on an Eiger media mill.

To this paste, the remaining ingredients were added with agitation:

| | | |
|---|---|---|
| 177 | g | Polyester-Acrylate 2 |
| 3 | g | Dimethyl ethanol amine |
| | | (50% Solution) |
| 37 | g | Deionized water |
| 4.2 | g | Cymel 327 from Ineos |
| 1.60 | g | Mineral Spirits |
| 1.6 | g | Byk-346 Additive from |
| | | Byk-Chemie |
| 1.5 | g | Byk-381 Additive from |
| | | Byk-Chemie |

Sample was reduced to 34 seconds #4 Ford cup viscosity. The final paint solids was 42% at a P/B ratio of 0.5:1. The organic solvent content of the above formulation is 3%. The effective resin solids content (minus water) is 92%. As used herein, “effective resin solids content (minus water)” can be calculated by the following formula:

resin solids (in grams)/(resin (in grams)+solvent (in grams))

Deposition of 100 g of the above anti-chip resin solids on the part will result in the environmental release of 8 g of solvent from this formulation.

### Coating Performance Results

TABLE 1
Comparison of Chip Resistance Performance

| | | Primer- | Chip | Galvanneal | Topcoat |
|---|---|---|---|---|---|
| Example | Anti-Chip | Surfacer | Rating | Failure | Adhesion |
| 1 | None | 70624 | 8+ | Large | − |
| 2 | None | OPP 2652 | 4 | Slight | + |
| 3 | 7H | 70624 | 2.5 | None | − |
| 4 | 7H | OPP 2652 | 2.0 | None | + |
| 7 | Paint 1 | 70624 | 2.0 | None | + |
| 8 | Paint 1 | OPP 2652 | 2.0 | None | + |

TABLE 2
Comparison of Chip Resistance/Appearance

| | | Primer- | | Galvanneal | |
|---|---|---|---|---|---|
| Example | Anti-Chip | Surfacer | Chip Rating | Failure | LW/SW |
| 9 | None | 70624 | 8+ | Large | 7.9/26 |
| 10 | 7H | 70624 | 4 | None | 17/39 |
| 11 | Paint 1 | 70624 | 2 | None | 12/45 |
| 12 | Paint 2 | 70624 | 2 | None | 9.6/32 |

Comparative Anti-Chip Coating Examples 3 and 4: These are urethane based anti-chip primers coded JWCPM-7H with a solids content of 25% is commercially available from PKAF. The organic solvent content of this formulation is 18%. The effective resin solids content (minus water) is 44%.

Deposition of 100 g of anti-chip resin solids on the part will result in the environmental release of 129 g of solvent with this formulation.

Primer Surfacer Coatings: Waterborne primer surfacer coatings were used in subsequent testing. OPP 2652 and 70624 are both commercially available from PPG Industries.

The above aqueous resinous binder compositions were evaluated as anti-chip primers under topcoats as follows: The test substrate was 4″×12″ACT HIA panels electrocoated with ED6450, a cationically electrodepositable primer commercially available from PPG Industries. These panels are available from ACT Laboratories of Hillsdale, Mich.

The anti-chip primer formulations were applied 1 coat at 60% relative humidity to give a dry film thickness of 6-8 microns and flashed for 5 minutes at ambient temperature. The primer surfacer compositions were spray applied (2 coats automated spray with 60 second ambient flash between coats) at 60% relative humidity and 21° C. to give a dry film thickness of 40 to 50 microns. The coated panels were flashed for 5 minutes at ambient temperature, and dehydrated for 5 minutes at 80° C. and then cured for 25 minutes at 140° C.

The coated panels were then topcoated with NHWB9761 black waterborne basecoat and NDCT 5002 acid/epoxy clearcoat. Both coatings are commercially available from PPG Industries. After topcoat was applied, the panels were cured for 30 minutes at 150° C. The coated panels were evaluated for chip resistance by cooling the test panels to −20° C. 250 gm of M2 brass hexagonally shaped nuts are then shot at the test panel with a Gravelometer at 5 kg/cm² at an angle of 45° to the panel surface. A gummed cloth tape is then applied to the panel surface to remove any loosened chips of paint. Panels are then ranked for failure area/failure location/topcoat adhesion. A larger numerical value indicates larger failure area. Chip failure in the galvanneal layer is not desired.

Gloss was measured with a micro-tri-gloss meter available from Byk-Gardner. Higher numbers indicate higher, more desirable gloss.

The hardness was measured on the primed only panels. This was done using a Pendulum Hardness Tester and measuring according to the Konig Method. The higher the value, the greater the hardness.

Solvent Resistance was tested on the primed only panels as well. This was done by placing a puddle of about 10 drops of acetone onto the panel and waiting for 10 seconds. After 10 seconds the acetone was removed with a cloth towel and a wooden spatula was scratched across the surface where the acetone had been. Rating is determined by the amount of mar left behind by the wooden blade. A passed (“P”) rating indicates little if any mar. A failed (“F”) rating indicates significant marring.

Appearance was measured on the topcoated panels. Appearance was measured using a BYK-wavescan (commercially available from BYK-Gardner) with data collected on the longwave and shortwave numbers. The instrument optically scans the wavy, light dark pattern on the surface over a distance of 10 cm and detects the reflected light intensity point by point. The measured optical profile is divided into long term waviness (structure size 0.6-10 mm) and short-term waviness (structure size 0.1-0.6 mm). The lower the value, the better the appearance.

The above table highlights the chip resistance improvement obtained when the anti-chip primer layer is used. The presence of anti-chip primer not only quantitatively improved overall chip resistance, it also mitigates the inherent chip resistance differences of the overlying primer surfacer layer (compare 1 vs. 2 and 3 vs. 4). The table finally reveals the outstanding level of chip resistance possible with the polyester based anti-chip primer of the current invention vs. the performance profile of the urethane based anti-chip primer.

What is claimed is:

1. A waterborne anti-chip primer coating composition comprising a polyester polyol having a molecular weight ≧1500 wherein the polyester polyol comprises ≧30 weight % of the total resin solids of the waterborne anti-chip primer coating composition; and wherein after application to a substrate as a coating and after curing has a dry film thickness ranging from 2 μm to 8 μm.

2. The waterborne anti-chip primer coating composition according to claim 1, wherein said polyester polyol is a reaction product of a polyether diol and trimellitic anhydride.

3. The waterborne anti-chip primer coating composition according to claim 2, wherein the molar ratio of polyether diol to trimellitic anhydride ranges from 4:2 to 5:3.

4. The waterborne anti-chip primer coating composition according to claim 1, wherein said polyester polyol comprises a primary branching point from which a plurality of branches extend.

5. The waterborne anti-chip primer coating composition according to claim 1, wherein said polyester polyol comprises reactive functional groups; and wherein said anti-chip primer coating composition comprise a curing agent that is reactive with the reactive functional groups of the polyester polyol.

6. A method of coating a substrate comprising:
applying a waterborne anti-chip primer coating composition onto at least a portion of the substrate, wherein the waterborne anti-chip primer coating composition comprises a polyester polyol having a molecular weight ≧1500, and wherein the polyester polyol comprises ≧30 weight % of the total resin solids of the waterborne anti-chip primer coating composition; and
curing said waterborne anti-chip primer coating composition such that the waterborne anti-chip primer coating composition has a dry film thickness ranging from 2 μm to 8 μm.

7. The method according to claim 6, wherein the method further comprises applying an electrodepositable coating composition onto at least a portion of said substrate and curing at least a portion of said electrodepositable coating composition prior to applying said waterborne anti-chip primer coating composition onto said substrate.

8. The method according to claim 6, wherein the method further comprises applying a basecoat coating composition onto at least a portion of said waterborne anti-chip primer coating composition prior to curing said waterborne anti-chip primer coating composition.

9. The method according to claim 8, wherein the method further comprises applying a substantially clear coating composition onto at least a portion of said basecoat coating composition prior to curing said waterborne anti-chip primer coating composition.

10. The method according to claim 6, wherein the method further comprises applying a primer-surfacer coating composition onto at least a portion of said waterborne anti-chip primer coating composition prior to curing said waterborne anti-chip primer coating composition; and said curing step further comprises curing said waterborne anti-chip primer coating composition and said primer-surfacer coating composition simultaneously.

11. The method according to claim 10, wherein the primer-surfacer coating composition comprises the reaction product of trimellitic anhydride and a polyol, wherein the molar ratio of trimellitic anhydride to said polyol in said reaction product ranges from 1:2 to 1:4, and wherein said reaction product is further reacted with an anhydride to form another reaction product.

12. The method according to claim 10, wherein the primer-surfacer coating composition comprises:
(a) polymeric microparticles obtained by aqueous phase addition polymerization of a monomer component comprising one or more addition polymerizable ethylenically unsaturated monomers in the presence of a polymer dispersed in aqueous medium in which the polymer is selected from a polyester, a polyurethane and an acrylic copolymer including mixtures thereof;
(b) a water-dilutable urethane polyol; and
(c) a hydroxyl group-containing material derived from the reaction of an epoxy group-containing material with a phosphorus acid.

13. A substrate comprising a coating system wherein the coating system comprises an anti-chip primer coating layer having a dry film thickness ranging from about 2 μm to 8 μm, and wherein the anti-chip primer coating layer results from a waterborne anti-chip coating composition comprising a polyester polyol wherein the polyester polyol has a molecular weight ≧1500, and wherein the polyester polyol comprises ≧30 weight % of the total resin solids of the waterborne anti-chip primer coating composition.

14. The substrate according to claim 13, wherein said coating system comprises an electrodeposited coating layer applied onto at least a portion of said substrate, and wherein said anti-chip primer coating layer is deposited onto at least a portion of said electrodeposited coating layer.

15. The substrate according to claim 13, wherein a basecoat coating layer is deposited onto at least a portion of said anti-chip primer coating layer.

16. The substrate according to claim 15, wherein a substantially clear coating layer is deposited onto at least apportion of said basecoat coating layer.

17. The substrate according to claim 13, wherein a primer-surfacer coating layer is deposited onto at least a portion of said anti-chip primer coating layer.

18. The substrate according to claim 17, wherein the primer-surfacer coating layer results from a primer-surfacer coating composition that comprises the reaction product of trimellitic anhydride and a polyol, wherein the molar ratio of trimellitic anhydride to said polyol in said reaction product ranges from 1:2 to 1:4, and wherein said reaction product is further reacted with an anhydride to form another reaction product.

19. The substrate according to claim 17, wherein the primer-surfacer coating layer results from a primer-surfacer coating composition that comprises:
(a) polymeric microparticles obtained by aqueous phase addition polymerization of a monomer component comprising one or more addition polymerizable ethylenically unsaturated monomers in the presence of a polymer dispersed in aqueous medium in which the polymer is selected from a polyester, a polyurethane and an acrylic copolymer including mixtures thereof;
(b) a water-dilutable urethane polyol; and
(c) a hydroxyl group-containing material derived from the reaction of an epoxy group-containing material with a phosphorus acid.

20. A waterborne anti-chip primer coating composition comprising the reaction product of a polyester polyol having a molecular weight ≧1500 and a polymerizable ethylenically unsaturated monomer, wherein the reaction product comprises ≧30 weight % of the total resin solids of the waterborne anti-chip primer coating composition; and wherein after application to a substrate as a coating and after curing has a dry film thickness ranging from 2 μm to 8 μm.

21. The waterborne anti-chip primer coating composition according to claim 20, wherein the polymerizable ethylenically unsaturated monomer comprises an acrylate monomer.
